(19) United States
(12) Patent Application Publication
(10) Pub. No.: US 2026/0113652 A1
(43) Pub. Date: Apr. 23, 2026

(54) POWER SAVING MECHANISM FOR MMWAVE 5G NR UE DEVICES

(71) Applicant: QUALCOMM Incorporated, San Diego, CA (US)

(72) Inventors: Mihir Vijay LAGHATE, San Diego, CA (US); Arnab PAL, Hyderabad (IN); Nagaraju GAJULA, San Diego, CA (US); Upamanyu JAMWAL, Mandi (IN)

(21) Appl. No.: 18/921,882

(22) Filed: Oct. 21, 2024

(51) Int. Cl. H04W 24/10; H04W 24/08

(52) U.S. Cl. CPC H04W 24/10; H04W 24/08

(57) ABSTRACT

The apparatus may be a wireless device such as a user equipment (UE) that may be configured to determine that a synchronization signal block (SSB) measurement occasion is not aligned with an on-duration of discontinuous reception (DRX), where a plurality of SSBs is associated with the SSB measurement occasion, determine, individually for each SSB in the plurality of SSBs, whether to exclude the SSB from measurement based on the determination that the SSB measurement occasion is not aligned with the on-duration of the DRX, and measure, or omit measurement for, each SSB in the plurality of SSBs based on the individual determination of whether to exclude the SSB from measurement.

### TECHNICAL FIELD

The present disclosure relates generally to communication systems, and more particularly, to power savings in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) that may be configured to determine that a synchronization signal block (SSB) measurement occasion is not aligned with an on-duration of discontinuous reception (DRX), where a plurality of SSBs is associated with the SSB measurement occasion, determine, individually for each SSB in the plurality of SSBs, whether to exclude the SSB from measurement based on the determination that the SSB measurement occasion is not aligned with the on-duration of the DRX, and measure, or omit measurement for, each SSB in the plurality of SSBs based on the individual determination of whether to exclude the SSB from measurement.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a set of connected mode DRX (CDRX) cycles and a corresponding set of SSB measurement occasions in accordance with some aspects of the disclosure.

FIG. 5 is a diagram illustrating a set of CDRX cycles and a corresponding set of SSB measurement occasions in accordance with some aspects of the disclosure.

FIG. 6 is a call flow diagram illustrating a method of wireless communication in accordance with some aspects of the disclosure.

FIG. 7 is a flowchart of a method for determining SSBs to monitor during a particular SSB measurement occasion in accordance with some aspects of the disclosure.

FIG. 8 is a diagram illustrating pseudo code associated with the methods of FIGS. 6 and 7 in accordance with some aspects of the disclosure.

FIG. 9 is a flowchart of a method of wireless communication.

FIG. 10 is a flowchart of a method of wireless communication.

FIG. 11 is a diagram illustrating an example of a hardware implementation for an apparatus.

### DETAILED DESCRIPTION

In some aspects of wireless communication, e.g., millimeter wave (mmWave), a network device and a wireless device (e.g., a base station and a UE) may maintain a beam pair link between the base station's serving SSB and the UE's serving receive (Rx) beam. The serving UE Rx beam may be a pseudo-omni (PO) beam (e.g., may be received by a PO antenna) or a refined beam based on coverage and a beam codebook. To get directive gain and more throughput, in some aspects, it is expected for a mmWave UE to transition from a PO beam to a refined UE Rx beam (e.g., to refine a PO Rx beam). Transitioning (or moving) from using a PO beam to using a refined beam (e.g., a refined UE Rx beam) for a UE may take some time based on many factors and UE may measure PO/refined beam per synchronization signal block (SSB) level (e.g., may determine a refined beam for receiving each SSB). During a search, a UE may try to find a new cell, a new SSB, and/or a new UE Rx beam and during measurement UE tries to measure detected SSBs.

In some aspects, there may be four symbols in an SSB and the UE may measure a set of the best four SSBs (e.g., a “top-4 SSBs”), where the best four SSBs may be based on a measured reference signal received power (RSRP) and/or signal-to-noise ratio (SNR). The best four SSBs may be measured with three different UE beams (e.g., scheduled for 3 different symbols) and other SSBs not in the set of the best four SSBs, may be scheduled for measurement using primarily one symbol (e.g., a secondary synchronization signal [SSS] symbol). In some aspects, a measured RSRP or SNR for the SSS (e.g., an SSS-RSRP or SSS-SNR) may be used for beam management purposes. In some aspects, a UE in certain modes of operation (e.g., in cell NORMAL mode and/or associated with a beam panic downsampling factor of 2×/4×/8×) may still measure each SSB burst set (SSBS) scheduled every 20 ms to refine a UE Rx beam quickly even when the UE is in a discontinuous reception (DRX), or connected mode DRX (CDRX), sleep. For simplicity, DRX may be used below to refer to either DRX or CDRX and may be used to describe any configuration of a sleep/wake cycle with an on-duration of DRX (or DRX ON period) associated with a larger set of active functions and/or components at a UE that may consume more power than an off-duration of DRX (or DRX OFF period) during which some components may be in a sleep mode (e.g., a DRX sleep). In addition to the sleep mode/DRX sleep, the UE may be capable of entering a microsleep state for periods shorter than the off-duration of DRX (or the DRX OFF period) that may be associated with a power consumption between a first power consumption associated with the “awake” state associated with the on-duration of DRX and a second power consumption associated with the off-duration of DRX (e.g., with the sleep mode/DRX sleep). In some aspects, each SSB measurement occasion (MO) (e.g., a time period during which SSBs associated with an SSBS may be transmitted) may span 4-5 ms in mmWave and, within an SSBS, a UE may not enable (or may not be able to enter) microsleep when a large number of SSBs (e.g., more than a threshold number of SSBs) are configured from a network. Based on an SSBS configuration and a CDRX configuration from a network, the SSBS may or may not align (e.g., in time) with a CDRX ON occasion (an on-duration of CDRX). An SSBS aligning with CDRX, in some aspects, may refer to the SSBS being the nearest SSBS to the CDRX ON duration such that UE power consumption will be lowest (e.g., the extension of the ON state to measure the SSBs of the SSBS may be the shortest).

In some aspects of wireless communication, such as 5G-NR mmWave connected mode, optimally determining SSBs for measurement during a measurement opportunities during a CDRX OFF period (or an off-duration of CDRX) may allow a UE to maintain balance between performance and power. For example, in practice (e.g., for a UE in the field), a network configuration may be associated with a large number of SSBs that are enabled from the network side. Of the large number of SSBs enabled from the network side, many SSBs which are spread across a 5 ms SSBS may be detected by a UE. In some aspects, a UE (whether stationary or non-stationary/mobile) may measure all detected SSBs. As a result, if the number of detected SSBs is large enough and/or is distributed throughout a measurement occasion (e.g., a 4-5 ms window associated with SSB transmission/reception for a 120 kHz subcarrier spacing), the UE may be measuring SSBs throughout the measurement occasion and may not be able to enter a sleep state until completing the measurements of the SSBs of the measurement occasion even if the measurement occasion occurs during an off-duration of DRX. A UE configured to measure all detected SSBs in each measurement occasion may not be able to save power within the 4-5 ms of an SSBS duration (e.g., a measurement occasion). For example, when there are a large number of detected SSBs distributed across the 4-5 ms measurement occasion, there may not be sufficient time between SSBs in the SSBS to conserve power by entering a microsleep state. Accordingly, radio frequency (RF) and firmware (FW) components may both be turned ON for the whole 4-5 ms duration because SSBs to be measured are spread in whole SSBs burst. Turning on all the RF and FW components for all detected SSBs and measuring them for all measurement occasions may be associated with a significant amount of power consumption. In mmWave connected mode, many measurement occasions may be associated with the UE measuring all detected SSBs with UE Rx beams (e.g., over the whole 4-5 ms window associated with the measurement occasion). Accordingly, the power consumption over the DRX wake/sleep cycle will increase relative to a UE that is able to sleep during the off-duration of DRX.

Various aspects relate generally to optimizing (e.g., limiting the number of) the SSBs measured during an off-duration of a DRX (or CDRX). Some aspects more specifically relate to excluding from measurement during an off-duration of DRX/CDRX all but the best four SSBs and strong SSBs of intra-frequency neighbor cells. In some examples, a wireless device such as a UE may be configured to determine that a SSB measurement occasion is not aligned with an on-duration of DRX/CDRX, where a plurality of SSBs is associated with the SSB measurement occasion, determine, individually for each SSB in the plurality of SSBs, whether to exclude the SSB from measurement based on the determination that the SSB measurement occasion is not aligned with the on-duration of the DRX, and measure, or omit measurement for, each SSB in the plurality of SSBs based on the individual determination of whether to exclude the SSB from measurement.

Particular aspects of the subject matter described in this disclosure can be implemented to realize one or more of the following potential advantages. In some examples, by limiting the number of SSBs measured (e.g., by excluding SSBs from measurement) during an off-duration of CDRX, the described techniques can be used to provide significant power saving for both stationary and non-stationary (e.g., mobile/moving wireless devices) while maintaining a similar level of performance based on the measurements of all detected SSBs performed during an on-duration of CDRX.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

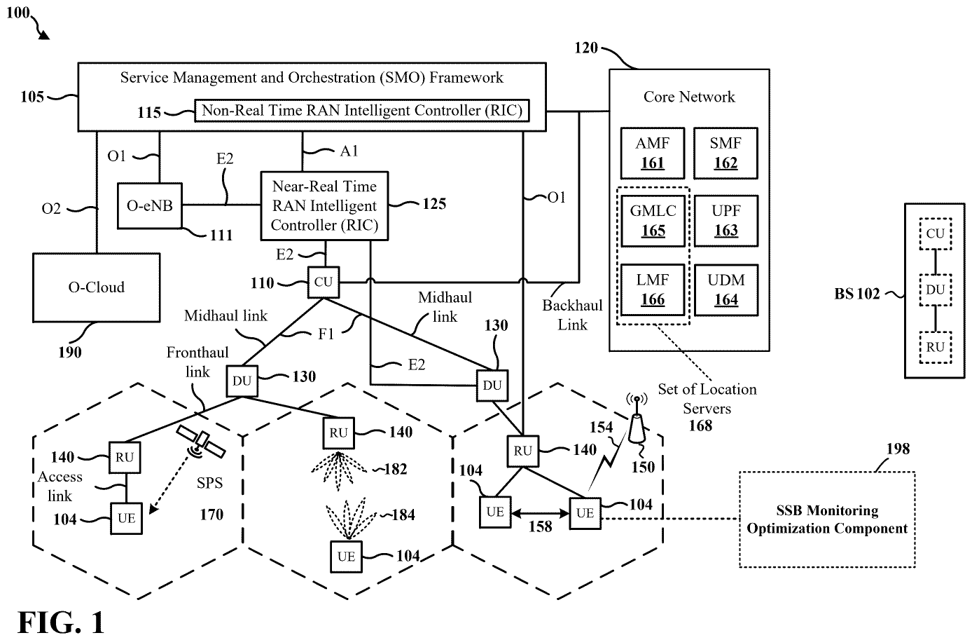

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a SSB monitoring optimization component 198 that may be configured to determine that a SSB measurement occasion is not aligned with an on-duration of DRX/CDRX, where a plurality of SSBs is associated with the SSB measurement occasion, determine, individually for each SSB in the plurality of SSBs, whether to exclude the SSB from measurement based on the determination that the SSB measurement occasion is not aligned with the on-duration of the DRX, and measure, or omit measurement for, each SSB in the plurality of SSBs based on the individual determination of whether to exclude the SSB from measurement. Although the following description may be focused on 5G NR, the concepts described herein may be applicable to other similar areas, such as LTE, LTE-A, CDMA, GSM, and other wireless technologies.

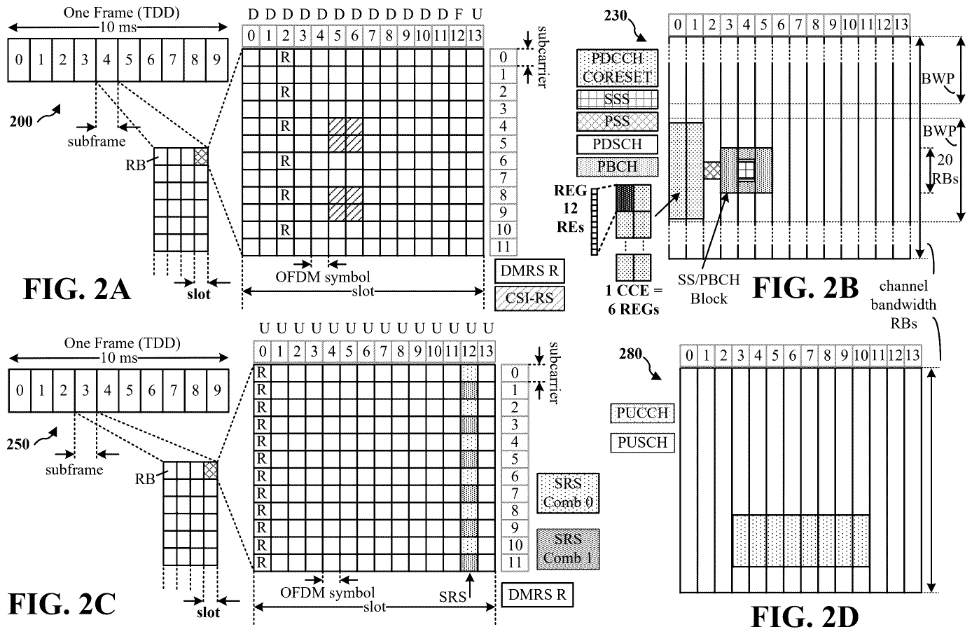

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2 slots/subframe. The subcarrier spacing may be equal to 2*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

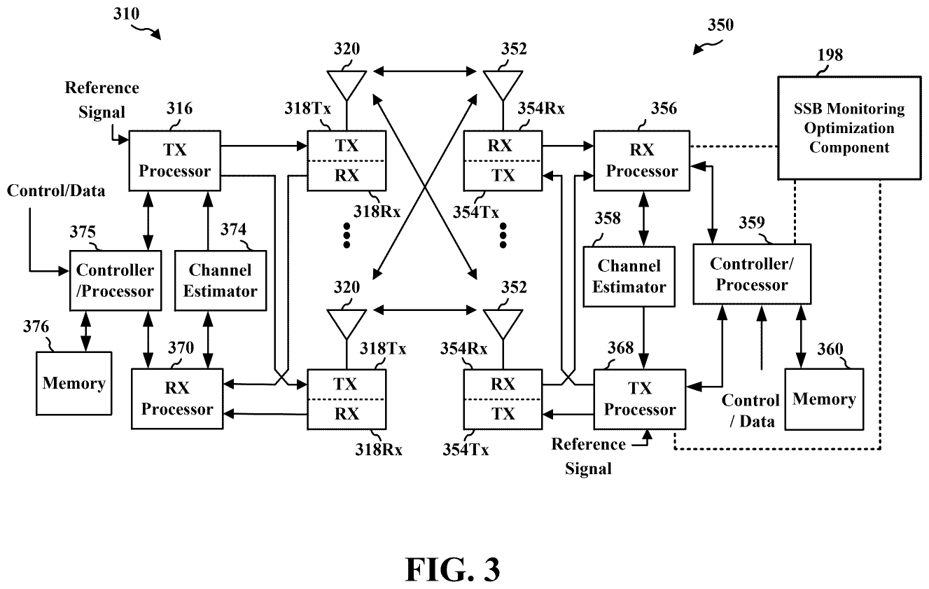

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SSB monitoring optimization component 198 of FIG. 1.

In some aspects of wireless communication, e.g., mmWave, a network device and a wireless device (e.g., a base station and a UE) may maintain a beam pair link between the base station's serving SSB and the UE's serving Rx beam. The serving UE Rx beam may be a PO beam (e.g., may be received by a PO antenna) or a refined beam based on coverage and a beam codebook. To get directive gain and more throughput, in some aspects, it is expected for a mmWave UE to transition from a PO beam to a refined UE Rx beam (e.g., to refine a PO Rx beam). Transitioning (or moving) from using a PO beam to using a refined beam (e.g., a refined UE Rx beam) for a UE may take some time based on many factors and UE may measure PO/refined beam per SSB level (e.g., may determine a refined beam for receiving each SSB). During a search, a UE may try to find a new cell, a new SSB, and/or a new UE Rx beam and during measurement UE tries to measure detected SSBs.

In some aspects, there may be four symbols in an SSB and the UE may measure a set of the best four SSBs (e.g., a “Top-4 SSBs”), where the best four SSBs may be based on a measured RSRP and/or SNR. The best four SSBs may be measured with three different UE beams (e.g., scheduled for 3 different symbols) and other SSBs not in the set of the best four SSBs, may be scheduled for measurement using primarily one symbol (e.g., a secondary synchronization signal [SSS] symbol). In some aspects, a measured RSRP or SNR for the SSS (e.g., an SSS-RSRP or SSS-SNR) may be used for beam management purposes. In some aspects, a UE in certain modes of operation (e.g., in cell NORMAL mode and/or beam panic downsampling factor of 2×/4×/8×) may still measure each SSBS scheduled every 20 ms to refine a UE Rx beam quickly even when the UE is in a DRX/CDRX sleep. In addition to the sleep mode/DRX sleep, the UE may be capable of entering a microsleep state for periods shorter than the off-duration of DRX (or the DRX OFF period) that may be associated with a power consumption between a first power consumption associated with the “awake” state associated with the on-duration of DRX and a second power consumption associated with the off-duration of DRX (e.g., with the sleep mode/DRX sleep). In some aspects, each SSB measurement occasion (e.g., a time period during which SSBs associated with an SSBS may be transmitted) may span 4-5 ms in mmWave and, within an SSBS, a UE may not enable (or may not be able to enter) microsleep when a large number of SSBs (e.g., more than a threshold number of SSBs) are configured from a network. Based on an SSBS configuration and a CDRX configuration from a network, the SSBS may or may not align (e.g., in time) with a CDRX ON occasion (an on-duration of CDRX). An SSBS aligning with CDRX, in some aspects, may refer to the SSBS being the nearest SSBS to the CDRX ON duration such that UE power consumption will be lowest (e.g., the extension of the ON state to measure the SSBs of the SSBS may be the shortest).

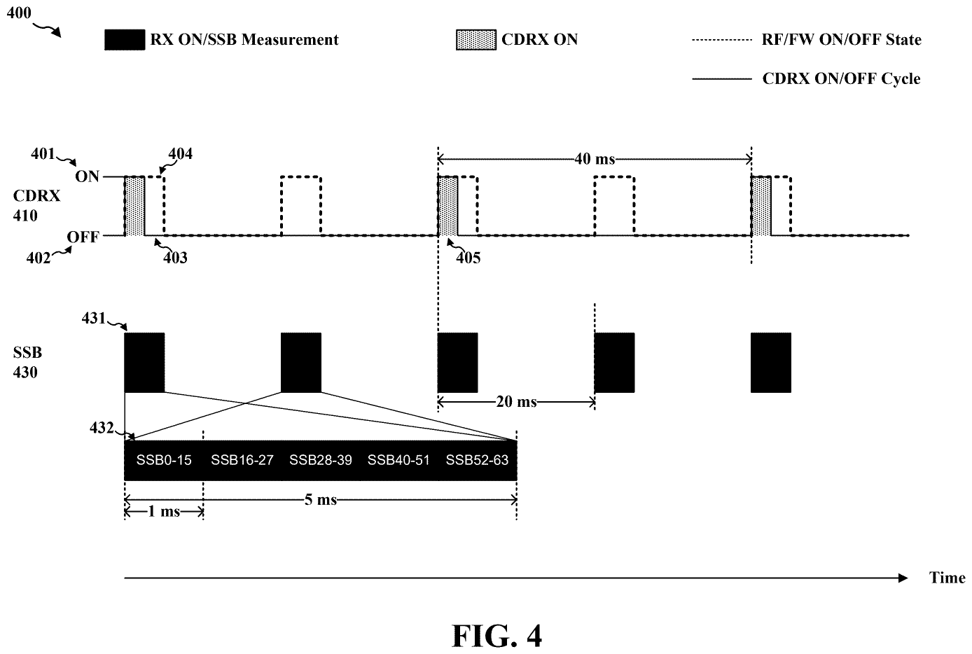

FIG. 4 is a diagram 400 illustrating a set of CDRX cycles and a corresponding set of SSB measurement occasions in accordance with some aspects of the disclosure. Diagram 400 illustrates a CDRX cycle 410 including an on-duration for CDRX 405 (e.g., a CDRX ON period). The CDRX cycle 410 also indicates an ON state 401 (e.g., a default state during an on-duration of CDRX) and an OFF state 402 (e.g., a default state during an off-duration of CDRX or a CDRX OFF period). A line 403 indicates the ON/OFF state for the UE based on the CDRX cycle in the absence of other considerations that may cause the UE to transition to an ON state during an off-duration of CDRX, or to stay in the ON state beyond the end of the on-duration of CDRX.

An SSB measurement occasion configuration 430 illustrates a set of SSB measurement occasions (e.g., SSB measurement occasion 431). An SSB measurement occasion, in some aspects, may span a set of SSB measurement windows (e.g., including a first SSB measurement window 432). Each SSB measurement window, in some aspects, may be associated with a set of SSB opportunities (indicated and/or identified by a set of SSB indexes). The SSB opportunities, in some aspects, are sets of symbols that may be used to transmit/receive an SSB. The pattern of SSB opportunities (and corresponding indexes) may be configured via one or more of a SIB1 message (e.g., via a ServingCellConfigCommonSlB field or information element [IE]) or RRC connection reconfiguration (e.g., via a ServingCellConfigCommon field or IE) and specific SSB indexes may be identified for measurement in a SIB2 message. The number of SSB indexes may be based on the SCS associated with the SSBs or the frequency used to transmit the SSBs. For example, SSB measurement occasion configuration 430 illustrates a set of 64 SSB indexes that may be used for a SCS of 120 KHz.

SSB measurement window 432, in some aspects, may be associated with SSB indexes 0-15 (a set of 16 SSB indexes), while subsequent SSB measurement windows may each be associated with a set of 12 SSBs in consecutive order (a second SSB measurement window may be associated with SSB indexes 16-27, a third SSB measurement window may be associated with SSB indexes 28-39, a fourth SSB measurement window may be associated with SSB indexes 40-51, and a fifth SSB measurement window may be associated with SSB indexes 52-63). In some aspects, SSB measurement window may be of 1 ms duration. The CDRX cycle 410 includes a line 404 that indicates the ON/OFF state for the UE based on the CDRX cycle and the SSB measurement occasions (e.g., SSB measurement occasions 431). As illustrated based on the mismatch between the duration of the CDRX ON period (e.g., 2.5 ms) and the period/periodicity of the CDRX (e.g., 40 ms) and the SSB measurement occasions (e.g., a duration of 5 ms and a period/periodicity of 20 ms), an aligned SSB measurement occasion (e.g., a closest SSB measurement occasion to the on-duration of CDRX) extends an ON state by at least 2.5 ms (when overlapping with the full duration of the on-duration of CDRX) and every other SSB measurement occasions occurs within the off-duration of CDRX and causes the UE to enter in to an ON state to measure the SSBs over the 5 ms duration of the SSB measurement occasion. In the particular example illustrated in FIG. 4, the total time spent in the ON state per CDRX cycle based on measuring all the SSBs in the SSB measurement occasions may be increased four-fold, e.g., from 2.5 ms every 40 ms to 10 ms every 40 ms. The increased time in the ON state is expected to significantly increase the average power consumption at the UE during CDRX operation.

In some aspects of wireless communication, such as 5G-NR mmWave connected mode, optimally determining SSBs for measurement during a measurement opportunities during a CDRX OFF period (or an off-duration of CDRX) may allow a UE to maintain balance between performance and power. For example, in practice (e.g., for a UE in the field), a network configuration may be associated with a large number of SSBs that are enabled from the network side. Of the large number of SSBs enabled from the network side, many SSBs which are spread across a 5 ms SSBS may be detected by a UE. In some aspects, a UE (whether stationary or non-stationary/mobile) may measure all detected SSBs. As a result, if the number of detected SSBs is large enough and/or is distributed throughout a measurement occasion (e.g., a 4-5 ms window associated with SSB transmission/reception for a 120 kHz subcarrier spacing), the UE may be measuring SSBs throughout the measurement occasion and may not be able to enter a sleep state until completing the measurements of the SSBs of the measurement occasion even if the measurement occasion occurs during an off-duration of DRX. A UE configured to measure all detected SSBs in each measurement occasion may not be able to save power within the 4-5 ms of an SSBS duration (e.g., a measurement occasion). For example, when there are a large number of detected SSBs distributed across the 4-5 ms measurement occasion, there may not be sufficient time between SSBs in the SSBS to conserve power by entering a microsleep state. Accordingly, radio frequency (RF) and firmware (FW) components may both be turned ON for the whole 4-5 ms duration because SSBs to be measured are spread in whole SSBs burst. Turning on all the RF and FW components for all detected SSBs and measuring them for all measurement occasions may be associated with a significant amount of power consumption. In mmWave connected mode, many measurement occasions may be associated with the UE measuring all detected SSBs with UE Rx beams (e.g., over the whole 4-5 ms window associated with the measurement occasion). Accordingly, the power consumption over the DRX wake/sleep cycle will increase relative to a UE that is able to sleep during the off-duration of DRX.

Various aspects relate generally to optimizing (e.g., limiting the number of) the SSBs measured during an off-duration of a DRX (or CDRX). Some aspects more specifically relate to excluding from measurement during an off-duration of DRX/CDRX all but the best four SSBs and strong SSBs of intra-frequency neighbor cells. In some examples, a wireless device such as a UE may be configured to determine that a SSB measurement occasion is not aligned with an on-duration of DRX/CDRX, where a plurality of SSBs is associated with the SSB measurement occasion, determine, individually for each SSB in the plurality of SSBs, whether to exclude the SSB from measurement based on the determination that the SSB measurement occasion is not aligned with the on-duration of the DRX, and measure, or omit measurement for, each SSB in the plurality of SSBs based on the individual determination of whether to exclude the SSB from measurement.

In some aspects, a number of SSBs to be measured during each mmWave measurement occasion may be limited for both stationary and non-stationary/motion devices. For SSB (or SSBS) measurement occasions aligned with a CDRX ON duration (e.g., a CDRX ON period or on-duration of CDRX), where being aligned with the CDRX ON duration refers to being the SSBS nearest to the CDRX ON duration such that the additional UE power consumption will be minimized, the UE may measure all detected SSBs. For SSBS measurement occasions not aligned with CDRX ON (for both stationary and non-stationary/motion use cases), the UE may schedule just the following two categories and/or classes of SSBs for measurement: (1) the serving cell TOP-4 SSBs and (2) the SSBs detected on neighbor cells with RSRP and/or SNR metrics that meet a threshold (e.g., the RSRP/SNR are greater than some predefined threshold in a modem chipset of the UE). In some aspects, by intelligently measuring a smaller number of SSBs inside a SSBS burst, the UE may be able to initiate a sleep in between SSB measurements and save a significant amount of power.

By selectively measuring a limited number of SSBs within a SSBS that is not aligned with (or not the closest to) a CDRX ON duration, the mmWave UE may save a lot of power as there are many measurement occasions. Measurement occasions overlapping, or aligned, with the CDRX ON duration may still be used to measure all detected SSBs (as in legacy deployments). While applied to SSBs, some aspects of the disclosure may be extended to other measurement scheduling inside CDRX sleep (e.g., during a CDRX OFF duration) for mmWave without impacting performance.

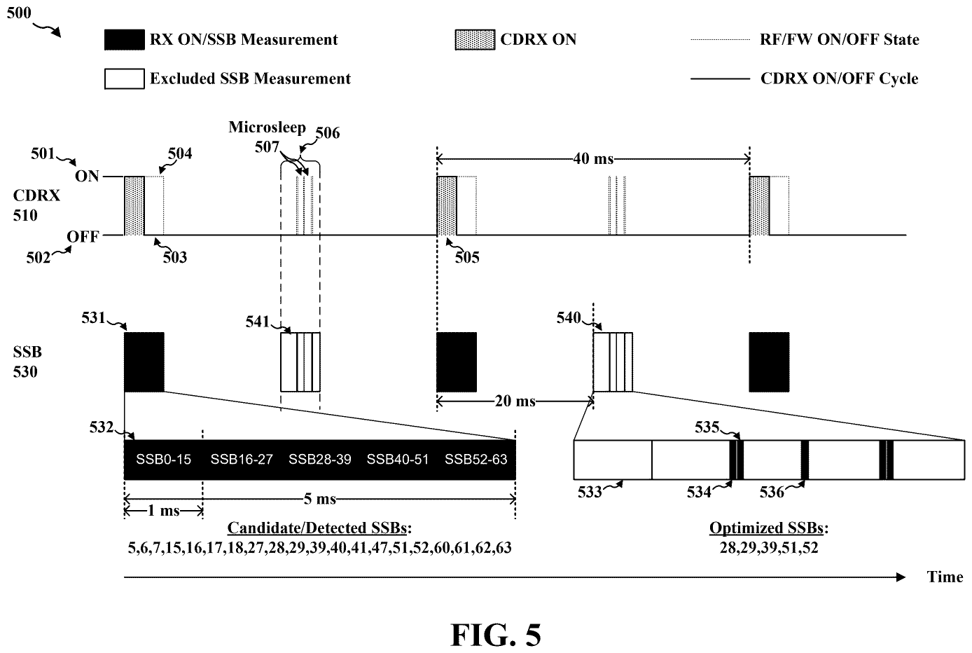

FIG. 5 is a diagram 500 illustrating a set of CDRX cycles and a corresponding set of SSB measurement occasions in accordance with some aspects of the disclosure. Diagram 500 illustrates a CDRX cycle 510 including an on-duration for CDRX 505 (e.g., a CDRX ON period). The CDRX cycle 510 also indicates an ON state 501 (e.g., a default state during an on-duration of CDRX) and an OFF state 502 (e.g., a default state during an off-duration of CDRX or a CDRX OFF period). A line 503 indicates the ON/OFF state for the UE based on the CDRX cycle in the absence of other considerations that may cause the UE to transition to an ON state during an off-duration of CDRX, or to stay in the ON state beyond the end of the on-duration of CDRX.

An SSB measurement occasion configuration 530 illustrates a set of SSB measurement occasions (e.g., SSB measurement occasion 531 and SSB measurement occasion 540). An SSB measurement occasion, in some aspects, may span a set of SSB measurement windows (e.g., including a first SSB measurement window 532). Each SSB measurement window, in some aspects, may be associated with a set of SSB opportunities (indicated by a set of SSB indexes). The number of SSB indexes may be based on the SCS associated with the SSBs or the frequency used to transmit the SSBs. For example, SSB measurement occasion configuration 530 illustrates a set of 64 SSB indexes that may be used for a SCS of 120 KHz.

SSB measurement window 532, in some aspects, may be associated with SSB indexes 0-15 (a set of 16 SSB indexes), while subsequent SSB measurement windows may each be associated with a set of 12 SSBs in consecutive order (a second SSB measurement window may be associated with SSB indexes 16-27, a third SSB measurement window may be associated with SSB indexes 28-39, a fourth SSB measurement window may be associated with SSB indexes 50-51, and a fifth SSB measurement window may be associated with SSB indexes 52-63). In some aspects, SSB measurement window may be of 1 ms duration. In some aspects, during a first SSB measurement occasion (e.g., SSB measurement occasion 531), the UE may measure SSBs and determine a plurality of candidate SSBs (e.g., a plurality of detected SSBs). In some aspects, the candidate SSBs may include SSBs associated with the following indexes: 5, 6, 7, 15, 16, 17, 18, 27, 28, 29, 39, 40, 41, 47, 51, 52, 60, 61, 62, and 63. A first subset of the candidate SSBs (e.g., SSBs associated with SSB indexes 5, 6, 7, 15, 16, 17, 18, 28, 39, 40, 51, 52, and 62) may be associated with a first cell serving the UE and a second subset of the candidate SSBs (e.g., SSBs associated with SSB indexes 27, 29, 40, 41, 47, 51, 60, 61, and 63) may be associated with one or more neighbor cells in some aspects. If measuring the candidate SSBs during the off-duration of CDRX as illustrated in relation to FIG. 4, the UE may consume a significant amount of power.

In some aspects, the UE may select and/or exclude a subset of the candidate SSBs. Based on a recent measurement (e.g., of a RSRP or SNR) of the candidate SSBs (e.g., the measurement made to detect the candidate SSBs), the UE may, in some aspects, determine which SSBs to exclude from monitoring (e.g., omit a monitoring for) during an off-duration of CDRX (e.g., based on determining that the SSB measurement occasion is not aligned with the on-duration of CDRX). For example, in some aspects, the UE may identify, from the first subset of SSBs, a set of SSBs associated with the strongest signals (e.g., the highest RSRPs or SNRs). The set of SSBs associated with the strongest signals may include a configured number of SSBs, e.g., four SSBs (e.g., SSBs associated with SSB indexes 28, 39, 51, and 52) that represent the “Top 4” SSBs. Additional SSBs associated with the serving cell may be excluded from measurement during an off-duration of CDRX. For SSBs in the second subset of SSBs associated with the neighbor cells, the UE may determine to exclude any SSBs (e.g., SSBs associated with SSB indexes 27, 40, 41, 47, 51, 60, 61, and 63) that are associated with (e.g., measured to have) an RSRP that is less than a threshold RSRP and/or an SNR that is less than a threshold SNR. Accordingly, in diagram 500, the UE may, during the SSB measurement occasion 540, exclude from measurement, or omit measuring of, the SSBs in a first SSB measurement window 533 and a second SSB measurement window and measure SSBs with SSB indexes 28 (SSB 534), 29 (SSB 535), 39 (SSB 536), 51, and 52. During the SSB measurement occasion 541, in some aspects, the UE may be able to maintain a sleep (or OFF) state until the beginning of the third SSB measurement window and re-enter the sleep (or OFF) state after measuring the SSBs with indexes 51 and 52. The UE may further be able to enter a sleep state (e.g., a microsleep state 507) between measuring the SSBs with indexes 29 and 39 (e.g., SSB 535 and SSB 536) and between measuring the SSBs with indexes 39 and 51.

For example, the CDRX cycle 510 includes the line 504 indicating the ON/OFF state for the UE based on the CDRX cycle and the SSB measurement occasions (e.g., SSB measurement occasion 531 and SSB measurement occasion 541) when excluding SSBs from the measurements during the off-duration of CDRX. As illustrated, the behavior of the UE may not change from the behavior described in relation to FIG. 4 for an aligned SSB measurement occasion 531, but the time spent in the ON state during a time period 506 overlapping the SSB measurement occasion 541 may be significantly reduced when compared to the time spent in the ON state during the off-duration of CDRX illustrated in relation to FIG. 4. For example, the time spent in the ON state may be approximately 0.2 ms to 0.5 ms when excluding SSBs from measurement compared to 5 ms when measuring all detected SSBs. The relative decrease of the time in the ON state (e.g., −5.5 ms vs. −10 ms) is expected to significantly decrease the average power consumption at the UE during CDRX operation when excluding SSBs from measurement during an off-duration of CDRX.

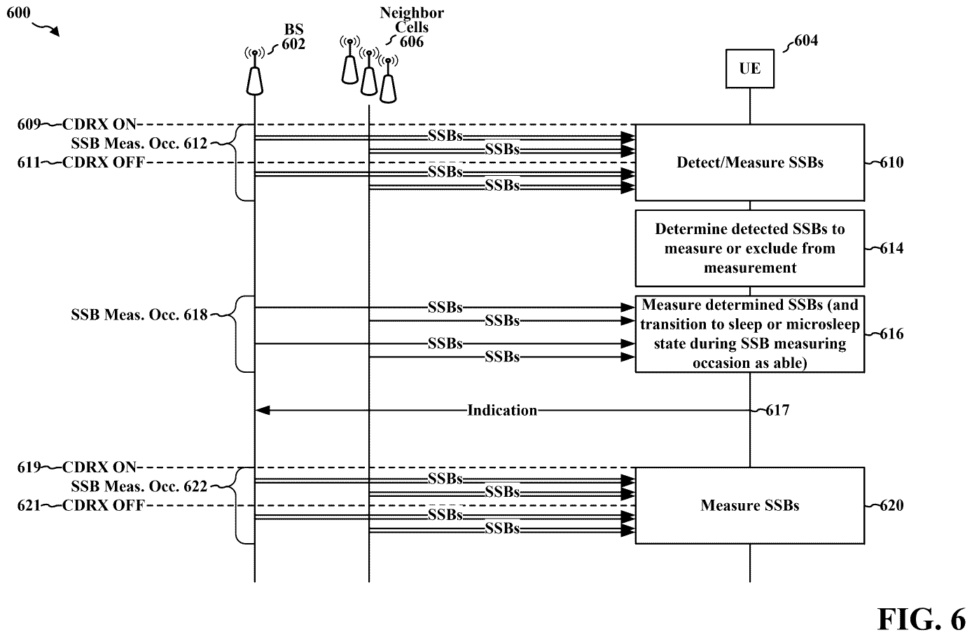

FIG. 6 is a call flow diagram 600 illustrating a method of wireless communication in accordance with some aspects of the disclosure. The method is illustrated in relation to a base station 602 (e.g., as an example of a network device or network node that may include one or more components of a disaggregated base station) and a set of neighbor cells 606 in communication with a UE 604 (e.g., as an example of a wireless device). The functions ascribed to the base station 602 or a neighbor cell in the set of neighbor cells 606, in some aspects, may be performed by one or more components of a network entity, a network node, or a network device (a single network entity/node/device or a disaggregated network entity/node/device as described above in relation to FIG. 1). Similarly, the functions ascribed to the UE 604, in some aspects, may be performed by one or more components of a wireless device supporting communication with a network entity/node/device. Accordingly, references to “transmitting” in the description below may be understood to refer to a first component of the base station 602, the neighbor cell in the set of neighbor cells 606, or the UE 604 outputting (or providing) an indication of the content of the transmission to be transmitted by a different component of the base station 602, the neighbor cell in the set of neighbor cells 606, or the UE 604. Similarly, references to “receiving” in the description below may be understood to refer to a first component of the base station 602, the neighbor cell in the set of neighbor cells 606, or the UE 604 receiving a transmitted signal and outputting (or providing) the received signal (or information based on the received signal) to a different component of the base station 602, the neighbor cell in the set of neighbor cells 606, or the UE 604.

While FIG. 6 refers to CDRX, it should be understood as a non-limiting example, such that the method discussed in relation to FIG. 6 may be applied to DRX more generally. During a first CDRX ON period 609 (or on-duration of CDRX) and extending into a CDRX OFF period 611 (or off-duration of CDRX), the UE 604 may, at 610, monitor for, detect, and/or measure a set of SSBs. The set of SSBs, in some aspects, may include SSBs associated with an SSB measurement occasion 612 (or SSBS) and transmitted from the base station 602 (e.g., a serving cell of the UE 604) and one or more neighbor cells in the set of neighbor cells 606 and received by the UE 604. In some aspects, each SSB may be received from one of the base station 602 or a particular neighbor cell in the set of neighbor cells 606 and may be associated with an SSB index associated with a timing of the SSB transmission within the SSB measurement occasion 612 (or SSBS). While illustrated to begin at the beginning of the CDRX ON period 609, in some aspects, the SSB measurement occasion 612 may begin before or after the CDRX ON period 609 such that none of the CDRX ON period or just a part of the CDRX ON period 609 overlaps with the SSB measurement occasion 612.

For each SSB (or for each SSB opportunity associated with an SSB index) received at the UE 604, the UE 604 may, at 610, measure the SSB, e.g., an RSRP or SNR of the received SSB, and determine, based on the measured RSRP and/or SNR, a plurality of SSBs that meet a minimum threshold for detection. In some aspects, the plurality of SSBs may include a first set of SSBs received from the base station 602 and a second set of SSBs received from a neighbor cell in the set of neighbor cells 606. At 614, the UE 604 may (individually) determine, for each SSB in the plurality of SSBs whether to exclude the SSB from measurement during an SSB measurement occasion (e.g., SSB measurement occasion 618) that is not aligned with the CDRX ON period (or on-duration of the DRX). In some aspects, the determination at 614 may be based on a source cell (e.g., whether the SSB was received from, or associated with, a serving cell or a neighbor cell) and a measurement (e.g., a measured RSRP or SNR) of the SSB.

For example, the determination at 614 for each SSB in the plurality of SSBs may include determining not to exclude (or to measure) the SSB when it is one of a first configured number (e.g., four) of the strongest signals (e.g., is in a group of the top-4 SSBs) associated with a first cell serving the UE (e.g., base station 602), determining not to exclude (or to measure) the SSB when it is associated with a neighbor cell (e.g., a non-serving cell such as a neighbor cell in the set of neighbor cells 606) and is received with one (or more) of a power (e.g., an RSRP) that is greater than a threshold power (or RSRP) or a first SNR that is greater than a threshold SNR, determining to exclude (or omit) the SSB when it is associated with the first cell serving the UE and is not one of the first configured number of strongest signals, or determining to exclude the SSB when it is associated with the neighbor cell and is received with one (or more) of the power (RSRP) that is less than the threshold power (RSRP) or a second SNR that is less than the threshold SNR. In some aspects, the UE 604 may consider either RSRP or SNR, while in other aspects, both RSRP and SNR may be used to determine whether to exclude (or omit) an SSB from measurement during a CDRX OFF period (e.g., an off-duration of CDRX). The UE 604, as part of the determination at 614, may output, for each SSB in the plurality of SSBs, an indication of the individual determination of whether to exclude the SSB from measurement. For example, outputting the indication may include storing the indication of the individual determination of whether to exclude the SSB from measurement.

Based on the determination at 614, the UE 604 may, at 616, measure the determined SSBs (e.g., the SSBs determined to not be excluded, or to be measured, based on the criteria discussed above) associated with the SSB measurement occasion 618 (or SSBS) during the CDRX OFF period 611. As illustrated, the number of measured SSBs is expected to be smaller than the number of SSBs measured in association with the SSB measurement occasion 612 that is the closest (or aligned) SSB measurement occasion to the CDRX ON period 609. Based on the smaller number of SSBs measured, the UE 604 may, at 616, transition between an ON state associated with measuring an SSB of the determined SSBs and a sleep, or microsleep, state (e.g., an OFF state) when not measuring an SSB of the determined SSBs as discussed in relation to FIG. 5. Based on the determination at 614 or the measuring at 616, the UE 604 may output, for each SSB in the plurality of SSBs, an indication of the individual determination of whether to exclude the SSB from measurement. For example, outputting the indication may include transmitting the indication 617 of the individual determination of whether to exclude the SSB from measurement that may be received by the base station 602, where the indication may be included in a measurement report regarding the measured SSBs.

During a next CDRX ON period 619 and extending into a next CDRX OFF period 621, the UE 604 may, at 620, monitor for, detect, and/or measure an additional set of SSBs. The additional set of SSBs, in some aspects, may include SSBs associated with an SSB measurement occasion 622 (or SSBS) similar to the set of SSBs associated with the SSB measurement occasion 612. As at 610, the UE 604 may, at 620, measure all SSB opportunities to detect (a plurality of) SSBs that are candidates for monitoring during a next SSB measurement occasion occurring during a CDRX OFF period (e.g., CDRX OFF period 621).

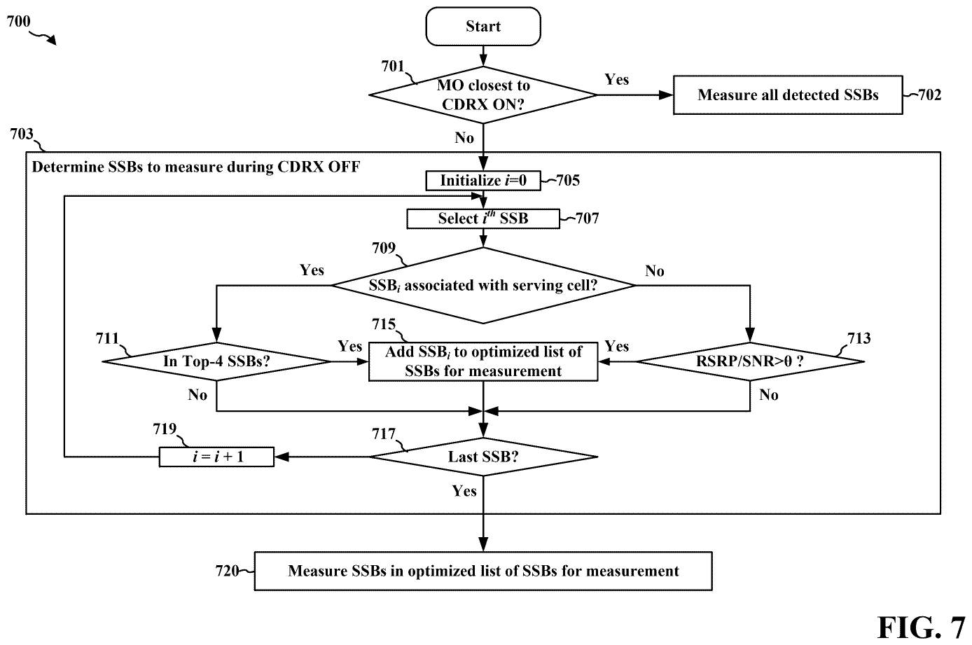

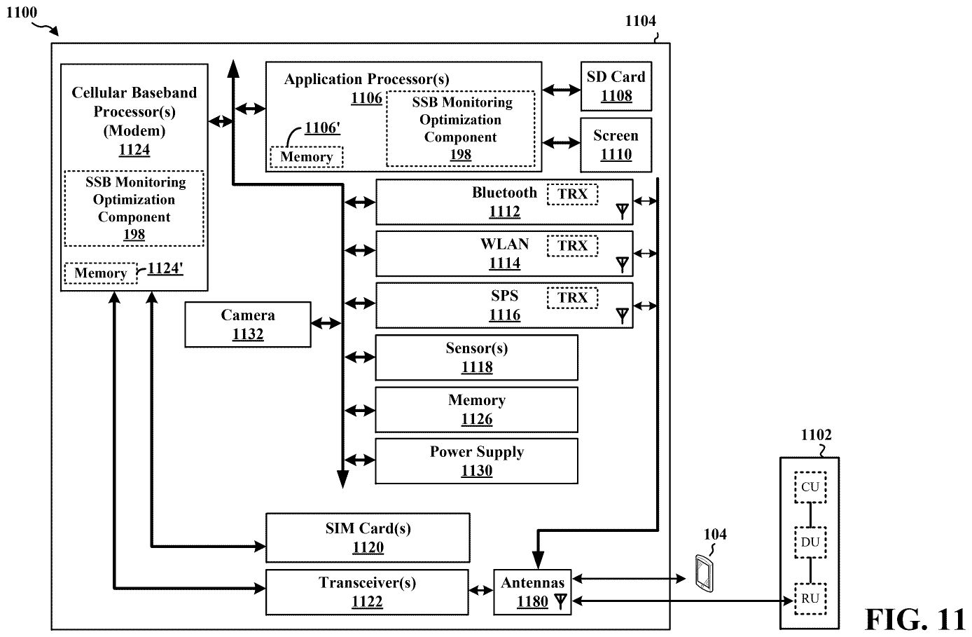

FIG. 7 is a flowchart 700 of a method for determining SSBs to monitor during a particular SSB measurement occasion in accordance with some aspects of the disclosure. The method may be performed by a UE (e.g., the UE 104, 604; the apparatus 1104). In some aspects, aspects of the method may be performed as part of the determination at 614 of FIG. 6. The method may be performed by application processor(s) 1106, cellular baseband processor(s) 1124, transceiver(s) 1122, antenna(s) 1180, and/or SSB monitoring optimization component 198 of FIG. 11. At 701, the UE may determine whether the particular SSB measurement occasion is aligned with a CDRX ON period (e.g., whether it is a closest SSB measurement occasion to the CDRX ON period). If, at 701, the UE determines that the particular SSB measurement occasion is aligned with the CDRX ON period, the UE may determine to measure all the detected SSBs (or monitor for an SSB on all the SSB opportunities in the particular SSB measurement occasion).

If, at 701, the UE determines that the particular SSB measurement occasion is not aligned with the CDRX ON period, the UE may proceed to determine, at 703, the (detected) SSBs to measure during the particular SSB measurement occasion occurring during the CDRX OFF period. Determining the SSBs to measure, in some aspects, may include determining for each SSB index (or SSB opportunity) whether to measure an associated SSB. In some aspects, the UE may begin by initializing, at 705, an index value “i” to 0 that may correspond to an SSB index associated with SSB opportunities during the particular SSB measurement occasion or an index into a list of detected SSBs and where the choice of starting index is arbitrary as long as all candidate SSB (e.g., all SSB indexes or all detected SSBs) are considered. Based on a current value of i, the UE may, at 707, select an SSB (an SSBi in an indexed list of all SSB opportunities in the particular SSB measurement occasion or in an indexed list of detected SSBs) for which to determine whether to exclude, or omit, from measuring or to include in the set of SSBs to measure during the particular SSB measurement occasion.

At 709, the UE may determine whether the selected SSB is associated with a serving cell (e.g., base station 602 of FIG. 6) or a neighbor cell (e.g., in the set of neighbor cells 606 of FIG. 6). If the UE determines, at 709, that the selected SSB is associated with the serving cell, the UE may determine, at 711, whether the selected SSB was measured to have, or is associated with, one of the four highest RSRPs or SNRs (while the RSRP and SNR are discussed in relation to FIG. 7, other measures of received signal strength or quality may be used to rank the “N” best SSBs). If the UE determines, at 711, that the selected SSB was measured to have one of the four highest RSRPs or SNRs, the selected SSB may be added, at 715, to an (optimized) list of SSBs to be measured during the particular SSB measurement occasion.

If the UE determines that the selected SSB was measured to not have one of the four highest RSRPs or SNRs, or after adding the selected SSB to the list at 715, the UE may proceed to determine, at 717, whether the selected SSB is the last SSB in a list or set of candidate SSBs (e.g., a list of detected SSBs or the SSB having the highest SSB index). If the UE determines that the selected SSB is not the last SSB in the list or set of candidate SSBs, the UE may proceed to increment the index value at 719 and continue to select a next SSB associated with the current (incremented) SSB index at 707.

If at 709, the UE determines that the selected SSB is not associated with the serving cell (e.g., is associated with a neighbor cell), the UE may determine, at 713, whether the selected SSB was measured to have, or is associated with, an RSRP or SNR that is greater than a corresponding RSRP threshold or SNR threshold (while the RSRP and SNR are discussed in relation to FIG. 7, other measures of received signal strength or quality may be used to identify signals received with sufficient power and/or quality). In some aspects, the RSRP threshold may be based on a value associated with event reporting (e.g., if the RSRP of the SSB of the neighbor cell is greater than an offset threshold associated with an event, such as A3 [neighbor cell becomes better than SpCell] subject to some adjustment). For example, the RSRP threshold may be set to “A3 offset threshold-2 dBm” or some other value based on measurements of the SSBs associated with the serving cell. If the UE determines, at 713, that the selected SSB was measured to have an RSRP or SNR that is greater than the corresponding RSRP threshold or SNR threshold, the selected SSB may be added, at 715, to an (optimized) list of SSBs to be measured during the particular SSB measurement occasion.

If the UE determines that the selected SSB was measured to not have an RSRP or SNR that is greater than the corresponding RSRP threshold or SNR threshold, or after adding the selected SSB to the list at 715, the UE may proceed to determine, at 717, whether the selected SSB is the last SSB in a list or set of candidate SSBs (e.g., a list of detected SSBs or the SSB having the highest SSB index). If, at 717, the UE determines that the selected SSB is not the last SSB in the list or set of candidate SSBs, the UE may proceed to increment the index value at 719 and continue to select a next SSB associated with the current (incremented) SSB index at 707.

If, at 717, the UE determines that the selected SSB is the last SSB in the list or set of candidate SSBs, the UE may proceed, at 720, to measure the SSBs in the (optimized) list of SSBs to be measured during the particular SSB measurement occasion (e.g., occurring during a CDRX OFF period).

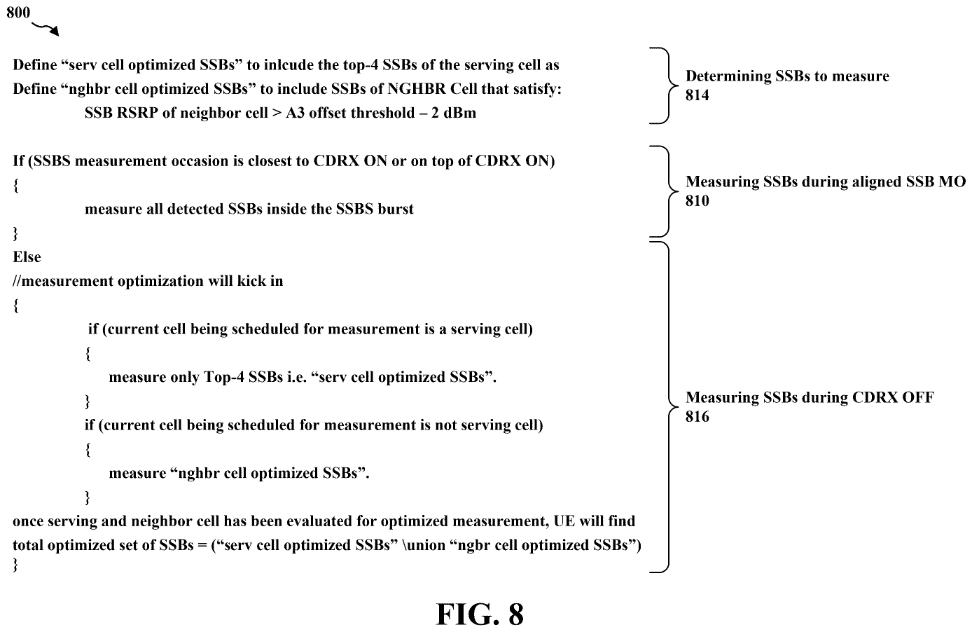

FIG. 8 is a diagram 800 illustrating pseudo code associated with the methods of FIGS. 6 and 7 in accordance with some aspects of the disclosure. For example, the UE may, based on the portion 814 of the pseudocode that may be associated with the determination at 614 of FIG. 6 or the determination at 703 of FIG. 7, determine (or define/identify) the SSBs to measure during the CDRX OFF period based on the criteria such as being the top-4 SSBs of the serving cell or having an RSRP above a threshold RSRP. Similarly, the UE may, based on the portion 810 of the pseudocode that may be associated with the monitoring for, detecting, and/or measuring of the set of SSBs at 610 and 620 or the determination at 701 that the SSB MO is closest to the CDRX ON period and measuring, at 702, all the detected SSBs (or SSB opportunities) of FIG. 7, measure all detected SSBs within an SSB burst (or SSBS). Finally, the UE may, based on the portion 816 of the pseudocode that may be associated with the measuring of the determined at 616 or the determination at 701 that the SSB MO is not aligned (e.g., not the closest to the CDRX ON period) and the measuring, at 720, of the SSBs in the (optimized) list of SSBs determined at 703 of FIG. 7, measure the SSBs included in the set of SSBs “serv cell optimized SSBs” associated with a serving cell and the set of SSBs “nghbr cell optimized SSBs” associated with neighbor cells.

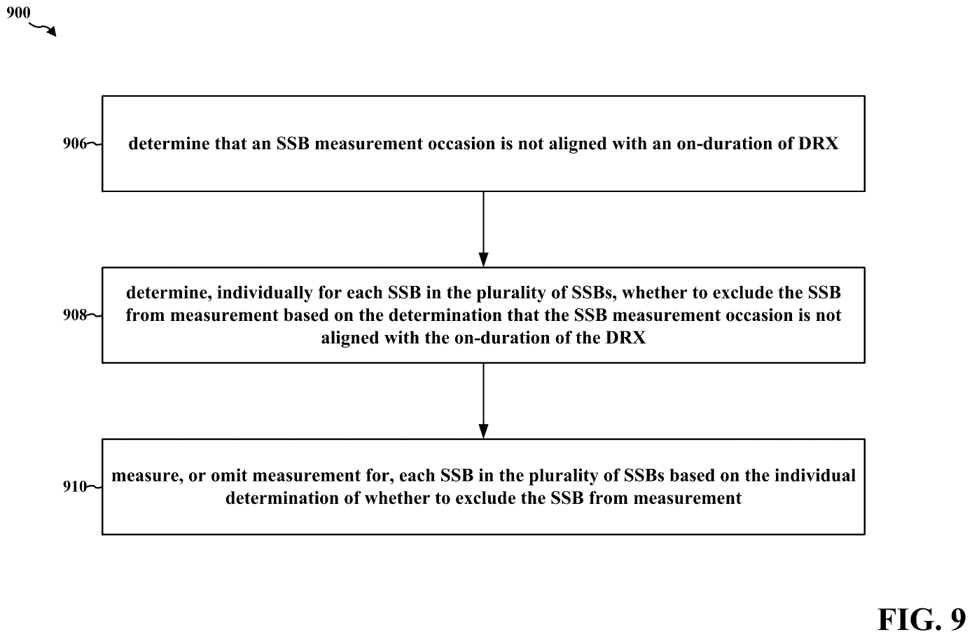

FIG. 9 is a flowchart 900 of a method of wireless communication. The method may be performed by a UE, such as a stationary UE or a non-stationary UE (e.g., the UE 104, 604; the apparatus 1104). In some aspects, the UE may measure SSBs in an SSBS during a first SSB measurement occasion. In some aspects, the measured SSBs may include all detected SSBs (e.g., detected by monitoring all SSB opportunities/SSB indexes associated with the SSBS and/or SSB measurement activity). For example, referring to FIG. 6, the UE 604 may, at 610, measure the set of SSBs, e.g., an RSRP or SNR of the received SSBs, in the set of SSBs associated with the SSB measurement occasion 612.

The UE, in some aspects, may determine a plurality of SSBs (a plurality of candidate SSBs) based on the measurements of the SSBs in the SSB burst set associated with the first SSB measurement occasion. In some aspects, determining the plurality of SSBs based on the measurements of the SSBs in the SSB burst set may include determining that each SSB in the plurality of SSBs is measured to be received with one of a power greater than a first threshold power or a SNR greater than a first threshold SNR. The first threshold power and the first SNR threshold may be associated with SSB detection. For example, referring to FIG. 6, the UE 604 may, at 614, determine, based on the RSRP and/or SNR measured at 610, a plurality of SSBs that meet a minimum threshold for detection.

At 906, the UE may determine that an SSB measurement occasion is not aligned with an on-duration of DRX. For example, 906 may be performed by application processor(s) 1106, cellular baseband processor(s) 1124, transceiver(s) 1122, antenna(s) 1180, and/or SSB monitoring optimization component 198 of FIG. 11. In some aspects, the plurality of SSBs may be associated with the SSB measurement occasion. In some aspects, determining that the SSB measurement occasion is not aligned with the on-duration of the DRX may include determining that the SSB measurement occasion is not a closest SSB measurement occasion to the on-duration of the DRX. For example, referring to FIGS. 6 and 7, the UE 604 may, as part of a determination at 614, determine that the SSB measurement occasion 618 is not aligned with the CDRX ON period as discussed in relation to the determination at 701.

At 908, the UE may determine, individually for each SSB in the plurality of SSBs and based on the determination that the SSB measurement occasion is not aligned with the on-duration of the DRX at 906, whether to exclude the SSB from measurement. In some aspects, determining, at 908, whether to exclude the SSB from measurement may include one of determining not to exclude the SSB when it is one of a first configured number of strongest signals associated with a first cell serving the UE, determining not to exclude the SSB when it is associated with one or more neighbor cells and is received with one or more of a first power that is greater than a threshold power or a first signal-to-noise ratio (SNR) that is greater than a threshold SNR, determining to exclude the SSB when it is associated with the first cell serving the UE and not one of the first configured number of strongest signals, or determining to exclude the SSB when it is associated with the one or more neighbor cells and is received with one or more of a second power that is less than the threshold power or a second SNR that is less than the threshold SNR. For example, 908 may be performed by application processor(s) 1106, cellular baseband processor(s) 1124, transceiver(s) 1122, antenna(s) 1180, and/or SSB monitoring optimization component 198 of FIG. 11. In some aspects, the first power may be an RSRP and the threshold power may be associated with an offset threshold. For example, referring to FIGS. 6 and 7, the UE 604 may, at 614, (individually) determine, for each SSB in the plurality of SSBs whether to exclude the SSB from measurement during an SSB measurement occasion (e.g., SSB measurement occasion 618) that is not aligned with the CDRX ON period (or on-duration of the DRX), or the UE may determine, at 703, the SSBs to measure during the SSB measurement occasion that is not aligned with the on-duration of the DRX.

In some aspects, based on the determination at 908, the UE may, at 910, measure, or omit measurement for, each SSB in the plurality of SSBs based on the individual determination of whether to exclude the SSB from measurement. For example, 910 may be performed by application processor(s) 1106, cellular baseband processor(s) 1124, transceiver(s) 1122, antenna(s) 1180, and/or SSB monitoring optimization component 198 of FIG. 11. The plurality of SSBs, in some aspects, may include a first SSB, a second SSB, and a third SSB, where the third SSB is scheduled between the first SSB and the second SSB within the SSB measurement occasion. The UE may determine, at 908, not to exclude the first SSB and the second SSB from measurement and determine, at 908, to exclude the third SSB from measurement and the UE may initiate, between measuring the first SSB and measuring the second SSB, a power saving mode of operation in which the UE omits the measurement of the third SSB. For example, referring to FIG. 6, the UE 604 may, at 616, measure the determined SSBs associated with the SSB measurement occasion 618 (or SSBS) during the CDRX OFF period 611, and the UE 604 may, at 616, transition between an ON state associated with measuring an SSB of the determined SSBs and a sleep, or microsleep, state (e.g., an OFF state) when not measuring an SSB of the determined SSBs as discussed in relation to FIG. 5.

In some aspects, the UE may output, for each SSB in the plurality of SSBs, an indication of the individual determination of whether to exclude the SSB from measurement. In some aspects, outputting the indication of the individual determination of whether to exclude the SSB from measurement may include transmitting the indication of the individual determination of whether to exclude the SSB from measurement or storing the indication of the individual determination of whether to exclude the SSB from measurement. For example, referring to FIG. 6, the UE 604 may, as part of the determination at 614, may output, for each SSB in the plurality of SSBs, an indication of the individual determination of whether to exclude the SSB from measurement, where outputting the indication may include storing the indication of the individual determination of whether to exclude the SSB from measurement or may transmitting the indication 617 of the individual determination of whether to exclude the SSB from measurement.

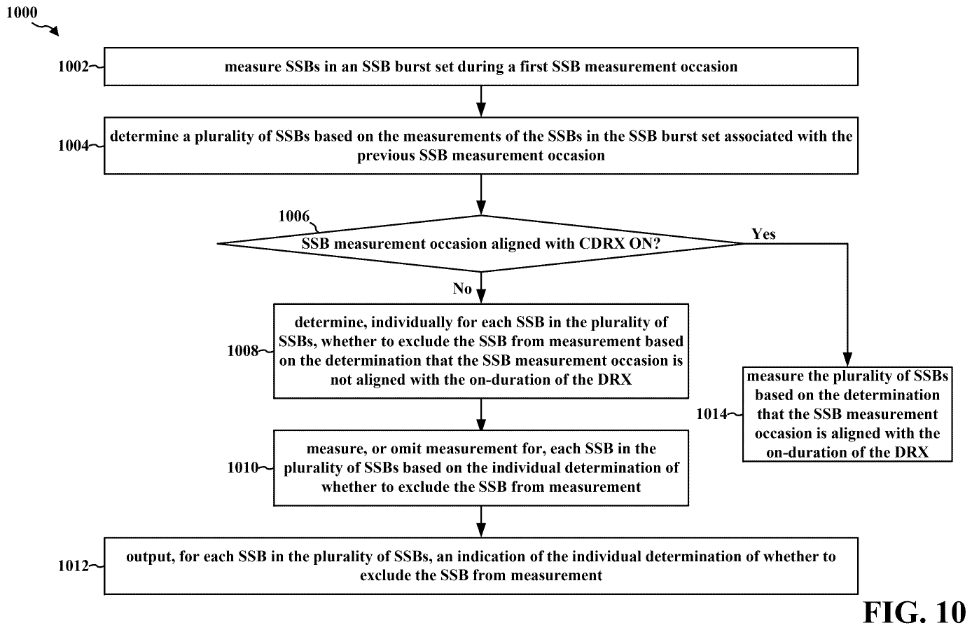

FIG. 10 is a flowchart 1000 of a method of wireless communication. The method may be performed by a UE, such as a stationary UE or a non-stationary UE (e.g., the UE 104, 604; the apparatus 1104). At 1002, the UE may measure SSBs in an SSB burst set (SSBS) during a first SSB measurement occasion. For example, 1002 may be performed by application processor(s) 1106, cellular baseband processor(s) 1124, transceiver(s) 1122, antenna(s) 1180, and/or SSB monitoring optimization component 198 of FIG. 11. In some aspects, the measured SSBs may include all detected SSBs (e.g., detected by monitoring all SSB opportunities/SSB indexes associated with the SSBS and/or SSB measurement activity). For example, referring to FIG. 6, the UE 604 may, at 610, measure the set of SSBs, e.g., an RSRP or SNR of the received SSBs, in the set of SSBs associated with the SSB measurement occasion 612.

At 1004, the UE may determine a plurality of SSBs (a plurality of candidate SSBs) based on the measurements of the SSBs in the SSB burst set associated with the first SSB measurement occasion. For example, 1004 may be performed by application processor(s) 1106, cellular baseband processor(s) 1124, transceiver(s) 1122, antenna(s) 1180, and/or SSB monitoring optimization component 198 of FIG. 11. In some aspects, determining the plurality of SSBs based on the measurements of the SSBs in the SSB burst set may include determining that each SSB in the plurality of SSBs is measured to be received with one of a power greater than a first threshold power or a SNR greater than a first threshold SNR. The first threshold power and the first SNR threshold may be associated with SSB detection. For example, referring to FIG. 6, the UE 604 may, at 614, determine, based on the RSRP and/or SNR measured at 610, a plurality of SSBs that meet a minimum threshold for detection.

At 1006, the UE may determine whether an SSB measurement occasion is aligned with an on-duration of DRX. For example, 1006 may be performed by application processor(s) 1106, cellular baseband processor(s) 1124, transceiver(s) 1122, antenna(s) 1180, and/or SSB monitoring optimization component 198 of FIG. 11. In some aspects, the plurality of SSBs may be associated with the SSB measurement occasion. For example, referring to FIGS. 6 and 7, the UE 604 may, as part of a determination at 614, determine whether an SSB measurement occasion is aligned with the CDRX ON period as discussed in relation to the determination at 701.

If the UE determines, at 1006, that the SSB measurement occasion is aligned with the on-duration of the DRX, the UE may, at 1014, measure, during the SSB measurement occasion, the plurality of SSBs based on the determination that the SSB measurement occasion is aligned with the on-duration of the DRX. In some aspects, determining that the SSB measurement occasion is aligned with the on-duration of the DRX includes determining that the SSB measurement occasion is a closest SSB measurement occasion to the on-duration of the DRX. For example, 1014 may be performed by application processor(s) 1106, cellular baseband processor(s) 1124, transceiver(s) 1122, antenna(s) 1180, and/or SSB monitoring optimization component 198 of FIG. 11. In some aspects, the plurality of (detected) SSBs may be associated with the SSB measurement occasion. For example, referring to FIGS. 6 and 7, the UE 604 may, at 610 and/or 620, measure the set of SSBs, e.g., an RSRP or SNR of the received SSBs, in the set of SSBs associated with the SSB measurement occasion 612 and/or 622 or the UE may measure, at 702, all the detected SSBs.

If the UE determines, at 1006, that the SSB measurement occasion is not aligned with the on-duration of the DRX, the UE may, at 1008, determine, individually for each SSB in the plurality of SSBs and based on the determination that the SSB measurement occasion is not aligned with the on-duration of the DRX, whether to exclude the SSB from measurement. In some aspects, determining, at 1008, whether to exclude the SSB from measurement may include one of determining not to exclude the SSB when it is one of a first configured number of strongest signals associated with a first cell serving the UE, determining not to exclude the SSB when it is associated with one or more neighbor cells and is received with one or more of a first power that is greater than a threshold power or a first signal-to-noise ratio (SNR) that is greater than a threshold SNR, determining to exclude the SSB when it is associated with the first cell serving the UE and not one of the first configured number of strongest signals, or determining to exclude the SSB when it is associated with the one or more neighbor cells and is received with one or more of a second power that is less than the threshold power or a second SNR that is less than the threshold SNR. For example, 1008 may be performed by application processor(s) 1106, cellular baseband processor(s) 1124, transceiver(s) 1122, antenna(s) 1180, and/or SSB monitoring optimization component 198 of FIG. 11. In some aspects, the first power may be an RSRP and the threshold power may be associated with an offset threshold. For example, referring to FIGS. 6 and 7, the UE 604 may, at 614, (individually) determine, for each SSB in the plurality of SSBs whether to exclude the SSB from measurement during an SSB measurement occasion (e.g., SSB measurement occasion 618) that is not aligned with the CDRX ON period (or on-duration of the DRX), or the UE may determine, at 703, the SSBs to measure during the SSB measurement occasion that is not aligned with the on-duration of the DRX.

In some aspects, based on the determination at 1008, the UE may, at 1010, measure, or omit measurement for, each SSB in the plurality of SSBs based on the individual determination of whether to exclude the SSB from measurement. For example, 1010 may be performed by application processor(s) 1106, cellular baseband processor(s) 1124, transceiver(s) 1122, antenna(s) 1180, and/or SSB monitoring optimization component 198 of FIG. 11. The plurality of SSBs, in some aspects, may include a first SSB, a second SSB, and a third SSB, where the third SSB is scheduled between the first SSB and the second SSB within the SSB measurement occasion. The UE may determine, at 1008, not to exclude the first SSB and the second SSB from measurement and determine, at 1008, to exclude the third SSB from measurement and the UE may initiate, between measuring the first SSB and measuring the second SSB, a power saving mode of operation in which the UE omits the measurement of the third SSB. For example, referring to FIG. 6, the UE 604 may, at 616, measure the determined SSBs associated with the SSB measurement occasion 618 (or SSBS) during the CDRX OFF period 611, and the UE 604 may, at 616, transition between an ON state associated with measuring an SSB of the determined SSBs and a sleep, or microsleep, state (e.g., an OFF state) when not measuring an SSB of the determined SSBs as discussed in relation to FIG. 5.

At 1012, in some aspects, the UE may output, for each SSB in the plurality of SSBs, an indication of the individual determination of whether to exclude the SSB from measurement. In some aspects, outputting, at 1012, the indication of the individual determination of whether to exclude the SSB from measurement may include transmitting the indication of the individual determination of whether to exclude the SSB from measurement or storing the indication of the individual determination of whether to exclude the SSB from measurement. For example, 1012 may be performed by application processor(s) 1106, cellular baseband processor(s) 1124, transceiver(s) 1122, antenna(s) 1180, and/or SSB monitoring optimization component 198 of FIG. 11. For example, referring to FIG. 6, the UE 604 may, as part of the determination at 614, may output, for each SSB in the plurality of SSBs, an indication of the individual determination of whether to exclude the SSB from measurement, where outputting the indication may include storing the indication of the individual determination of whether to exclude the SSB from measurement or may transmitting the indication 617 of the individual determination of whether to exclude the SSB from measurement.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize one or more antennas 1180 for communication. The cellular baseband processor(s) 1124 communicates through the transceiver(s) 1122 via the one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the SSB monitoring optimization component 198 may be configured to determine that a SSB measurement occasion is not aligned with an on-duration of DRX/CDRX, where a plurality of SSBs is associated with the SSB measurement occasion, determine, individually for each SSB in the plurality of SSBs, whether to exclude the SSB from measurement based on the determination that the SSB measurement occasion is not aligned with the on-duration of the DRX, and measure, or omit measurement for, each SSB in the plurality of SSBs based on the individual determination of whether to exclude the SSB from measurement. The SSB monitoring optimization component 198 may be within the cellular baseband processor(s) 1124, the application processor(s) 1106, or both the cellular baseband processor(s) 1124 and the application processor(s) 1106. The SSB monitoring optimization component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for determining that a SSB measurement occasion is not aligned with an on-duration of DRX. The apparatus 1104, and in particular the cellular baseband processor(s) 1124 and/or the application processor(s) 1106, may include means for determining, individually for each SSB in the plurality of SSBs, whether to exclude the SSB from measurement based on the determination that the SSB measurement occasion is not aligned with the on-duration of the DRX. The apparatus 1104, and in particular the cellular baseband processor(s) 1124 and/or the application processor(s) 1106, may include means for measuring, or omitting measurement for, each SSB in the plurality of SSBs based on the individual determination of whether to exclude the SSB from measurement. The apparatus 1104, and in particular the cellular baseband processor(s) 1124 and/or the application processor(s) 1106, may include means for initiating, between measuring the first SSB and measuring the second SSB, a power saving mode of operation in which the UE omits the measurement of the third SSB. The apparatus 1104, and in particular the cellular baseband processor(s) 1124 and/or the application processor(s) 1106, may include means for determining that a subsequent SSB measurement occasion is aligned with the on-duration of the DRX. The apparatus 1104, and in particular the cellular baseband processor(s) 1124 and/or the application processor(s) 1106, may include means for measuring, during the subsequent SSB measurement occasion, the plurality of SSBs based on the determination that the subsequent SSB measurement occasion is aligned with the on-duration of the DRX. The apparatus 1104, and in particular the cellular baseband processor(s) 1124 and/or the application processor(s) 1106, may include means for determining that the subsequent SSB measurement occasion is a closest subsequent SSB measurement occasion to the on-duration of the DRX. The apparatus 1104, and in particular the cellular baseband processor(s) 1124 and/or the application processor(s) 1106, may include means for determining not to exclude the SSB when it is one of a first configured number of strongest signals associated with a first cell serving the UE. The apparatus 1104, and in particular the cellular baseband processor(s) 1124 and/or the application processor(s) 1106, may include means for determining not to exclude the SSB when it is associated with a neighbor cell and is received with one or more of a first power that is greater than a threshold power or a first SNR that is greater than a threshold SNR. The apparatus 1104, and in particular the cellular baseband processor(s) 1124 and/or the application processor(s) 1106, may include means for determining to exclude the SSB when it is associated with the first cell serving the UE and not one of the first configured number of strongest signals. The apparatus 1104, and in particular the cellular baseband processor(s) 1124 and/or the application processor(s) 1106, may include means for determining to exclude the SSB when it is associated with the one or more neighbor cells and is received with one or more of a second power that is less than the threshold power or a second SNR that is less than the threshold SNR. The apparatus 1104, and in particular the cellular baseband processor(s) 1124 and/or the application processor(s) 1106, may include means for measuring SSBs in an SSB burst set during a previous SSB measurement occasion. The apparatus 1104, and in particular the cellular baseband processor(s) 1124 and/or the application processor(s) 1106, may include means for determining the plurality of SSBs based on the measurements of the SSBs in the SSB burst set associated with the previous SSB measurement occasion. The apparatus 1104, and in particular the cellular baseband processor(s) 1124 and/or the application processor(s) 1106, may include means for determining that each SSB in the plurality of SSBs is measured to be received with one of a power greater than a threshold power or a signal-to-noise ratio (SNR) greater than a threshold SNR. The apparatus 1104, and in particular the cellular baseband processor(s) 1124 and/or the application processor(s) 1106, may include means for outputting, for each SSB in the plurality of SSBs, an indication of the individual determination of whether to exclude the SSB from measurement. The apparatus 1104, and in particular the cellular baseband processor(s) 1124 and/or the application processor(s) 1106, may include means for transmitting the indication of the individual determination of whether to exclude the SSB from measurement. The apparatus 1104, and in particular the cellular baseband processor(s) 1124 and/or the application processor(s) 1106, may include means for storing the indication of the individual determination of whether to exclude the SSB from measurement.

The apparatus 1104 may further include means for performing any of the aspects described in connection with the flowcharts in FIG. 9 or 10, and/or performed by the UE in the communication flow of FIG. 6. The means may be the SSB monitoring optimization component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

Various aspects relate generally to limiting the number of SSBs measured during an off-duration of a DRX (or CDRX). Some aspects more specifically relate to excluding from measurement during an off-duration of DRX/CDRX all but the best four SSBs and strong SSBs of intra-frequency neighbor cells. In some examples, a wireless device such as a UE may be configured to determine that a SSB measurement occasion is not aligned with an on-duration of DRX/CDRX, where a plurality of SSBs is associated with the SSB measurement occasion, determine, individually for each SSB in the plurality of SSBs, whether to exclude the SSB from measurement based on the determination that the SSB measurement occasion is not aligned with the on-duration of the DRX, and measure, or omit measurement for, each SSB in the plurality of SSBs based on the individual determination of whether to exclude the SSB from measurement.

Particular aspects of the subject matter described in this disclosure can be implemented to realize one or more of the following potential advantages. In some examples, by limiting the number of SSBs measured (e.g., by excluding SSBs from measurement) during an off-duration of CDRX, the described techniques can be used to conserve power during the off-duration of CDRX.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: determining that a synchronization signal block (SSB) measurement occasion is not aligned with an on-duration of discontinuous reception (DRX), wherein a plurality of SSBs is associated with the SSB measurement occasion; determining, individually for each SSB in the plurality of SSBs, whether to exclude the SSB from measurement based on the determination that the SSB measurement occasion is not aligned with the on-duration of the DRX; and measuring, or omitting measurement for, each SSB in the plurality of SSBs based on the individual determination of whether to exclude the SSB from measurement.

Aspect 2 is the method of aspect 1, wherein the plurality of SSBs comprises a first SSB, a second SSB, and a third SSB, and wherein the UE determines not to exclude the first SSB and the second SSB from measurement and determines to exclude the third SSB from measurement and wherein the third SSB is scheduled between the first SSB and the second SSB within the SSB measurement occasion, the method further comprising: initiating, between measuring the first SSB and measuring the second SSB, a power saving mode of operation in which the UE omits the measurement of the third SSB.

Aspect 3 is the method of any of aspects 1 and 2, further comprising: determining that a subsequent SSB measurement occasion is aligned with the on-duration of the DRX, wherein the plurality of SSBs is associated with the subsequent SSB measurement occasion; and measuring, during the subsequent SSB measurement occasion, the plurality of SSBs based on the determination that the subsequent SSB measurement occasion is aligned with the on-duration of the DRX.

Aspect 4 is the method of aspect 3, wherein determining that the subsequent SSB measurement occasion is aligned with the on-duration of the DRX comprises determining that the subsequent SSB measurement occasion is a closest subsequent SSB measurement occasion to the on-duration of the DRX.

Aspect 5 is the method of any of aspects 1 to 4, wherein determining, individually for each SSB in the plurality of SSBs, whether to exclude the SSB from measurement based on the determination that the SSB measurement occasion is not aligned with the on-duration of the DRX comprises one of: determining not to exclude the SSB when the SSB is one of a first configured number of strongest signals associated with a first cell serving the UE; determining not to exclude the SSB when the SSB is associated with a neighbor cell and is received with one or more of a first power that is greater than a threshold power or a first signal-to-noise ratio (SNR) that is greater than a threshold SNR; determining to exclude the SSB when the SSB is associated with the first cell serving the UE and not one of the first configured number of strongest signals; or determining to exclude the SSB when the SSB is associated with the one or more neighbor cells and is received with one or more of a second power that is less than the threshold power or a second SNR that is less than the threshold SNR.

Aspect 6 is the method of aspect 5, wherein the first power is a reference signal received power (RSRP) and the threshold power is associated with an offset threshold.

Aspect 7 is the method of any of aspects 1 to 6, wherein the UE is a stationary UE.

Aspect 8 is the method of any of aspects 1 to 6, wherein the UE is a non-stationary UE.

Aspect 9 is the method of any of aspects 1 to 8, further comprising: measuring SSBs in an SSB burst set during a previous SSB measurement occasion; and determining the plurality of SSBs based on the measurements of the SSBs in the SSB burst set associated with the previous SSB measurement occasion.

Aspect 10 is the method of aspect 9, wherein determining the plurality of SSBs based on the measurements of the SSBs in the SSB burst set associated with the previous SSB measurement occasion comprises: determining that each SSB in the plurality of SSBs is measured to be received with one of a power greater than a threshold power or a signal-to-noise ratio (SNR) greater than a threshold SNR.

Aspect 11 is the method of any of aspects 1 to 10, further comprising: outputting, for each SSB in the plurality of SSBs, an indication of the individual determination of whether to exclude the SSB from measurement.

Aspect 12 is the method of aspect 11, wherein outputting the indication of the individual determination of whether to exclude the SSB from measurement comprises: transmitting the indication of the individual determination of whether to exclude the SSB from measurement; or storing the indication of the individual determination of whether to exclude the SSB from measurement.

Aspect 13 is an apparatus for wireless communication at a device including a memory and at least one processor coupled to the memory and, based at least in part on information stored in the memory, the at least one processor is configured to implement any of aspects 1 to 12.

Aspect 14 is the apparatus of aspect 13, further including a transceiver or an antenna coupled to the at least one processor.

Aspect 15 is an apparatus for wireless communication at a device including means for implementing any of aspects 1 to 12.

Aspect 16 is a computer-readable medium (e.g., a non-transitory computer-readable medium) storing computer executable code, where the code when executed by a processor causes the processor to implement any of aspects 1 to 12.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
determine that a synchronization signal block (SSB) measurement occasion is not aligned with an on-duration of discontinuous reception (DRX), wherein a plurality of SSBs is associated with the SSB measurement occasion;
determine, individually for each SSB in the plurality of SSBs, whether to exclude the SSB from measurement based on the determination that the SSB measurement occasion is not aligned with the on-duration of the DRX; and
measure, or omit measurement for, each SSB in the plurality of SSBs based on the individual determination of whether to exclude the SSB from measurement.

2. The apparatus of claim 1, wherein the plurality of SSBs comprises a first SSB, a second SSB, and a third SSB, and wherein the UE determines not to exclude the first SSB and the second SSB from measurement and determines to exclude the third SSB from measurement and wherein the third SSB is scheduled between the first SSB and the second SSB within the SSB measurement occasion, wherein the at least one processor, individually or in any combination, is further configured to:
initiate, between measuring the first SSB and measuring the second SSB, a power saving mode of operation in which the UE omits the measurement of the third SSB.

3. The apparatus of claim 1, wherein the at least one processor, individually or in any combination, is further configured to:
determine that a subsequent SSB measurement occasion is aligned with the on-duration of the DRX, wherein the plurality of SSBs is associated with the subsequent SSB measurement occasion; and
measure, during the subsequent SSB measurement occasion, the plurality of SSBs based on the determination that the subsequent SSB measurement occasion is aligned with the on-duration of the DRX.

4. The apparatus of claim 3, wherein, to determine that the subsequent SSB measurement occasion is aligned with the on-duration of the DRX, the at least one processor, individually or in any combination, is configured to determine that the subsequent SSB measurement occasion is a closest subsequent SSB measurement occasion to the on-duration of the DRX.

5. The apparatus of claim 1, wherein, to determine, individually for each SSB in the plurality of SSBs, whether to exclude the SSB from measurement based on the determination that the SSB measurement occasion is not aligned with the on-duration of the DRX, the at least one processor, individually or in any combination, is configured to one of:
determine not to exclude the SSB when the SSB is one of a first configured number of strongest signals associated with a first cell serving the UE;
determine not to exclude the SSB when the SSB is associated with a neighbor cell and is received with one or more of a first power that is greater than a threshold power or a first signal-to-noise ratio (SNR) that is greater than a threshold SNR;
determine to exclude the SSB when the SSB is associated with the first cell serving the UE and not one of the first configured number of strongest signals; or
determine to exclude the SSB when the SSB is associated with the one or more neighbor cells and is received with one or more of a second power that is less than the threshold power or a second SNR that is less than the threshold SNR.

6. The apparatus of claim 5, wherein the first power is a reference signal received power (RSRP) and the threshold power is associated with an offset threshold.

7. The apparatus of claim 1, wherein the UE is a stationary UE.

8. The apparatus of claim 1, wherein the UE is a non-stationary UE.

9. The apparatus of claim 1, wherein the at least one processor, individually or in any combination, is further configured to:
measure SSBs in an SSB burst set during a previous SSB measurement occasion; and
determine the plurality of SSBs based on the measurements of the SSBs in the SSB burst set associated with the previous SSB measurement occasion.

10. The apparatus of claim 9, wherein, to determine the plurality of SSBs based on the measurements of the SSBs in the SSB burst set associated with the previous SSB measurement occasion, the at least one processor, individually or in any combination, is configured to:
determine that each SSB in the plurality of SSBs is measured to be received with one of a power greater than a threshold power or a signal-to-noise ratio (SNR) greater than a threshold SNR.

11. The apparatus of claim 1, wherein the at least one processor, individually or in any combination, is further configured to:
output, for each SSB in the plurality of SSBs, an indication of the individual determination of whether to exclude the SSB from measurement.

12. The apparatus of claim 11, further comprising a transceiver coupled to the at least one processor, wherein, to output the indication of the individual determination of whether to exclude the SSB from measurement, the at least one processor, individually or in any combination, is further configured to:
transmit, via the transceiver, the indication of the individual determination of whether to exclude the SSB from measurement; or
store the indication of the individual determination of whether to exclude the SSB from measurement.

13. A method of wireless communication at a user equipment (UE), comprising:
determining that a synchronization signal block (SSB) measurement occasion is not aligned with an on-duration of discontinuous reception (DRX), wherein a plurality of SSBs is associated with the SSB measurement occasion;
determining, individually for each SSB in the plurality of SSBs, whether to exclude the SSB from measurement based on the determination that the SSB measurement occasion is not aligned with the on-duration of the DRX; and
measuring, or omitting measurement for, each SSB in the plurality of SSBs based on the individual determination of whether to exclude the SSB from measurement.

14. The method of claim 13, wherein the plurality of SSBs comprises a first SSB, a second SSB, and a third SSB, and wherein the UE determines not to exclude the first SSB and the second SSB from measurement and determines to exclude the third SSB from measurement and wherein the third SSB is scheduled between the first SSB and the second SSB within the SSB measurement occasion, the method further comprising:
initiating, between measuring the first SSB and measuring the second SSB, a power saving mode of operation in which the UE omits the measurement of the third SSB.

15. The method of claim 13, further comprising:
determining, by determining that a subsequent SSB measurement occasion is a closest subsequent SSB measurement occasion to the on-duration of the DRX, that the subsequent SSB measurement occasion is aligned with the on-duration of the DRX, wherein the plurality of SSBs is associated with the subsequent SSB measurement occasion; and
measuring, during the subsequent SSB measurement occasion, the plurality of SSBs based on the determination that the subsequent SSB measurement occasion is aligned with the on-duration of the DRX.

16. The method of claim 13, wherein determining, individually for each SSB in the plurality of SSBs, whether to exclude the SSB from measurement based on the determination that the SSB measurement occasion is not aligned with the on-duration of the DRX comprises one of:
determining not to exclude the SSB when it is one of a first configured number of strongest signals associated with a first cell serving the UE;
determining not to exclude the SSB when it is associated with a neighbor cell and is received with one or more of a first power that is greater than a threshold power or a first signal-to-noise ratio (SNR) that is greater than a threshold SNR;
determining to exclude the SSB when it is associated with the first cell serving the UE and not one of the first configured number of strongest signals; or
determining to exclude the SSB when it is associated with the one or more neighbor cells and is received with one or more of a second power that is less than the threshold power or a second SNR that is less than the threshold SNR.

17. The method of claim 13, wherein the UE is a stationary UE.

18. The method of claim 13, further comprising:
measuring SSBs in an SSB burst set during a previous SSB measurement occasion; and
determining the plurality of SSBs based on the measurements of the SSBs in the SSB burst set associated with the previous SSB measurement occasion.

19. The method of claim 13, wherein outputting an indication of the individual determination of whether to exclude the SSB from measurement by at least one of:
transmitting the indication of the individual determination of whether to exclude the SSB from measurement; or
storing the indication of the individual determination of whether to exclude the SSB from measurement.

20. A computer-readable medium storing computer executable code at a user equipment (UE), the code when executed by a processor causes the processor to:
determine that a synchronization signal block (SSB) measurement occasion is not aligned with an on-duration of discontinuous reception (DRX), wherein a plurality of SSBs is associated with the SSB measurement occasion;
determine, individually for each SSB in the plurality of SSBs, whether to exclude the SSB from measurement based on the determination that the SSB measurement occasion is not aligned with the on-duration of the DRX; and
measure, or omit measurement for, each SSB in the plurality of SSBs based on the individual determination of whether to exclude the SSB from measurement.
